(19) United States
(12) Patent Application Publication
(10) Pub. No.: US 2005/0060740 A1
(43) Pub. Date: Mar. 17, 2005

(54) Passive media ratings enforcement system

(75) Inventor: Polly Stecyk, Fountain Valley, CA (US)

Correspondence Address: ORRICK, HERRINGTON & SUTCLIFFE, LLP, 4 PARK PLAZA, SUITE 1600, IRVINE, CA, 92614-2558, US

(73) Assignee: Mitsubishi Digital Electronics America, Inc.

(21) Appl. No.: 10/663,016

(22) Filed: Sep. 15, 2003

(51) Int. Cl. H04N 7/16

(52) U.S. Cl. 725/28; 725/25

(57) ABSTRACT

Systems, methods and apparatuses are provided for allowing a user to supervise personal exposure to a program exhibited by a consumer electronics device, such as, e.g., a television system. The consumer electronics device includes a facial recognition system and media rating enforcement circuitry that analyzes a program signal and either blocks or passes the program signal based on certain content and viewer based criteria and also, in the alternative, time based criteria. In this connection, a user can program the enforcement circuitry with the content and viewer based criteria in the form of one or more viewing profiles comprising viewer specifications and content-based specifications associated with the viewer specifications, and, which specify a rating and/or a subject matter category. The enforcement circuitry receives one or more viewer indicators from a facial recognition system that are indicative of the viewers present in a viewing area and one or more content-based indicators, which are indicative of a rating and/or a subject matter category of the program. The enforcement circuitry compares the viewer indicators with the viewer specifications and then the content-based indicators with the content-based specifications. Based on this comparison, the enforcement circuitry either passes the program signal to an output device for transformation of the program signal into the program or blocks the program signal from being sent to the output device.

### FIELD OF THE INVENTION

This invention relates to the field of consumer electronics devices, and more particularly to methods and systems for limiting personal exposure to a television system or other consumer electronics device through passive enforcement of media ratings.

### BACKGROUND

There has been long-standing concern on the part of parents or guardians as to the content of programs and other media viewed by children and minors. This concern has been long-standing with respect to television broadcasts, and more recently, with respect to on-line services such as those provided through service providers or through other electronic means of text and image-based communication.

Various attempts have been made to limit access by children to subject matter that is deemed inappropriate. Certain locks simply block specific channels, where those channels are either known to or are suspected to carry programming which is deemed unacceptable for viewing by children. Other systems incorporate time-based limitations, for example, where the entire television may not be used during certain hours. Typically, the set time limits would preclude operation of the system during “bedtime” hours or at times when parental supervision does not exist, e.g., after school hours. Yet other lock systems serve to make the entirety of the system unavailable other than to authorized users.

Various attempts have been made to provide more refined lock systems. One attempt, the so-called “V-chip” system, utilizes a coding system indicative of content: For example, a given show may have a rating designation such as TV-Y7, TV-PG, TV-14 or TV-MA and a category designation such as adult language, violence or sexual situations, which are used to further restrict the rating designator. These indicators are often provided by single letter designators, such as L, V and S, respectively. Other coding systems analogous to movie rating codes, such as G for general audience, PG for parental guidance, R for restricted, etc., may also serve as a censor-based assessment of the content. These content-based designators are carried in television systems over the extended data service (XDS or EDS) system. The adopted standard for NTSC television is the EIA-608 standard. Information which is typically carried in such systems includes the network name, show title, and brief description of the contents of the show. There are currently proposals to include rating information of the type previously mentioned in the XDS data.

FIG. 1 shows a typical format of EIA-608 standards as a function of time. Initially, a horizontal sync pulse 10 initiates a pulse train. A color burst pulse 12 follows the horizontal sync pulse, and is typically provided for all line scans. Next, a clock run-in-signal 14 serves as a synchronizing signal. A sequence of start bits 16, labeled S1, S2 and S3 follow. As depicted, the pulse train here is shown with pulse S3 being “high” and S1 and S2 being “low.” In the extended data service system, various characters are then provided. Character one 18 is composed of bits (labeled B0, B1, B2, B3, B4, B5 and B6) and a parity check bit 22 (labeled P1). Character two 24 is composed of bits (labeled B0, B1, B2, B3, B4, B5, B6 and B7) and a parity check bit 26 (labeled P2) for the byte of character two 24. Typically, the XDS data is carried on a line, which is not visible on the television display, such as line 21.

FIG. 2 shows a schematic drawing of the prior art V-chip system. A television or other display 30 is the ultimate recipient of display information. Initially, some source of information such as a television signal 32 is supplied from any number of sources, such as over-the-air transmission, cable or other recorded source. Channel selector 34 controls the tuner 36 to select the desired information from television signal 32. The output of tuner 36 is an audio/video signal 38 corresponding to the channel selected. A data slicer 40 is coupled to the output of the tuner 36. The data slicer 40 functions to monitor the XDS signal as carried in the audio/video signal 38. The data slicer 40 may either strip the XDS signal from the audio/video signal 38 or simply duplicate the XDS signal. With the V-chip system, the XDS data obtained by the data slicer 40 is program rating information. The program rating information is supplied from the data slicer 40 to the comparator 42. A list 44 of prohibited ratings is stored or provided. Typically, the system would identify all prohibited ratings by level, such as R and X, though a system could utilize logic to prohibit any rating at a given level or above (the convention above meaning more mature or more likely to be prohibited). In the event of coincidence between the output of the data slicer 40 comprising the rating data of the program and the list of prohibited ratings 44, the comparator 42 provides a blocking signal 46 to signal blocking mechanism 48. The signal blocking mechanism 48 functions as a switch, blocking or otherwise scrambling audio/video signal 38, such that the show having the prohibited rating is not displayed.

Such systems are considered active systems in that a system administrator (or parent) must continuously enable/disable the system with the use of digital codes. This requires the parent to continuously disable the V-chip system during adult viewing and enable the V-chip system during child viewing. This can become quite tedious, and more importantly, leaves open the possibility that the parent may forget to enable the V-chip system when adult viewing has ended.

### SUMMARY OF THE INVENTION

This present invention comprises novel methods, apparatuses and systems for supervising personal exposure to a consumer electronics device, such as, e.g., a television system, by reviewing programs for a selected content threshold in regard to particular viewers and, in the alternative, not reviewing programs for selected content threshold in regard to particular viewers during a finite time period.

In a preferred method of the present invention, a program signal is received by a consumer electronics device having a facial recognition system and an enforcement or intervention mechanism such as “V-chip” circuitry. The program signal, without intervention, is transformed into user discernible information for exhibition to a user. In the case of a television system, the user discernible information may represent itself as a picture and sound. In addition to the program signal, one or more viewer indicators and one or more content-based indicators are received. The viewer indicators, which are received from the facial recognition system, are indicative of the viewers present in the viewing area associated with the consumer electronics device and scanned by the facial recognition system's camera. The content-based indicators, such as, e.g., a television or movie rating or a subject matter category, are indicative of the content of the user discernible information and can be carried by the program signal itself, or they can originate from some other source. One or more viewer specifications can be selected and one or more content-based specifications, such as, e.g., a rating or subject matter category, associated with each of the viewer specifications can then be selected to create viewing profiles for selected viewers. Either the user or the manufacturer can effect selection by programming the viewer specifications and associated content-based specifications into the “V-chip” circuitry.

Each of the viewer indicators are compared to the selected viewer specifications to determine which viewing profiles are active. Each of the received content-based indicators is then compared to the selected content-based specifications of the active viewing profiles. In response to the comparison, a control signal is generated, which either causes the program signal to be impaired (block control signal), for instance by means of blocking or scrambling, or unimpaired (pass control signal). In the case of a television system, one or more of the video, audio, or closed captioning aspects of the program signal can be impaired. The block control signal can be generated if a received content-based indicator exceeds (if rating) or matches (if categorical) a selected content-based indicator. The pass control signal can be generated if none of the received content-based indicators exceeds (if rating) or matches (if categorical) selected content-based specifications.

In a preferred embodiment of the present invention, a consumer electronics device includes a facial recognition system comprising a computer or CPU running facial recognition software and a camera coupled to the CPU to continuously scan the associated viewing area, and “V-chip” circuitry comprising a logic unit, non-volatile memory and a signal impairing mechanism. The “V-chip” circuitry can be utilized in a television system, a video cassette recorder, audio equipment, or any consumer electronics device whereby user discernible information can be generated. The “V-chip” circuitry allows the consumer electronics device to transform a program signal into user discernible information if the program signal meets certain content based criteria associated with a viewer, and prevents the consumer electronics device from transforming the program signal into user discernible information if the program signal does not meet certain content and viewer based criteria.

In this regard, the logic unit is coupled to non-volatile memory and is configured for performing the following upon execution of instructions stored within the non-volatile memory. The logic unit receives one or more viewer indicators from a facial recognition system and one or more content-based indicators, which, if carried by the program signal, can be extracted or copied by a data extraction device, such as, e.g., a data slicer. The logic unit also receives one or more viewer specifications and associated content-based specifications, which have been selected by either the user or the manufacturer and stored in the non-volatile memory. The logic unit compares the viewer indicators with the viewer specifications to identify the active viewing profile(s) and then compares the received content-based indicators with selected content-based specifications when the viewer indicators fall within any of the viewer specifications. The logic unit then generates either a pass control signal or a blocking control signal based on these comparisons.

The signal impairing device receives the program signal and is configured for either passing the program signal there through without substantial impairment or passing the program signal therethrough with substantial impairment. The signal impairing device is coupled to the logic unit for receiving the control signals therefrom. Upon receipt of the block control signal, the signal impairing device blocks or scrambles the program signal. Upon receipt of the pass control signal, the signal impairing device passes the program signal through without substantial impairment.

In an alternate embodiment of the present invention, a program signal, one or more viewer indicators and one or more content-based indicators, is received by a consumer electronics device, and without intervention is transformed into user discernible information for exhibition to a user. In addition to the program signal, one or more viewer indicators and one or more content-based indicators, timing information, such as, e.g., the current time, is also received. The content-based indicators and timing information can be carried by the program signal itself, or they can originate from some other source. One or more viewer and finite time range specifications can be selected and one or more content-based specifications associated with each of the viewer and time range specifications can then be selected to create viewing profiles for selected viewers. Either the user or the manufacturer can effect selection by programming the viewer specification and associated content-based specification and finite time range specifications into the “V-chip” circuitry.

Other and further objects, features, aspects, and advantages of the present invention will become better understood with the following detailed description of the accompanying drawings.

### BRIEF DESCRIPTION OF THE DRAWINGS

The drawings illustrate both the design and utility of preferred embodiments of the present invention, in which:

FIG. 1 shows the prior art EIA-608 standards, depicting a typical signal as a function of time;

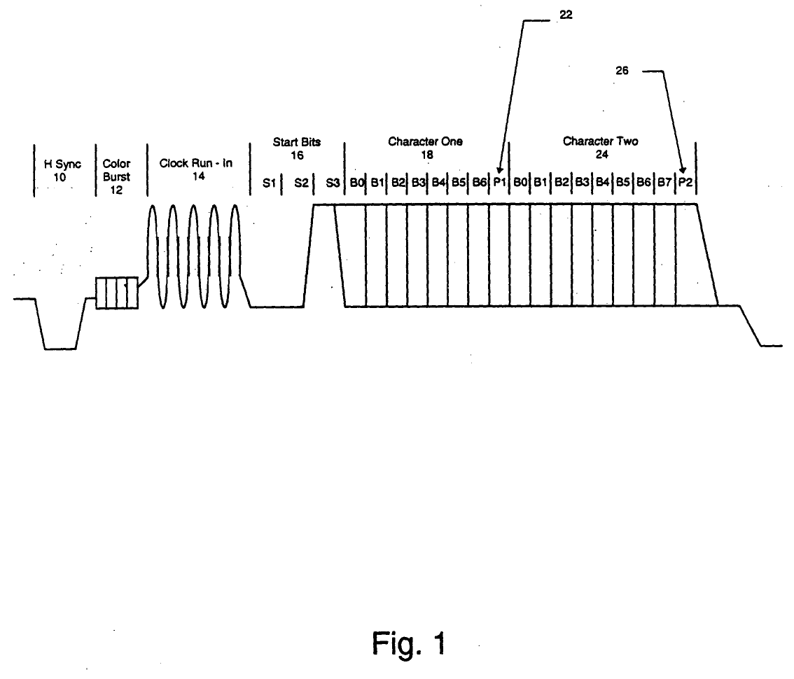

FIG. 2 is a schematic drawing of the prior art “V-chip” system;

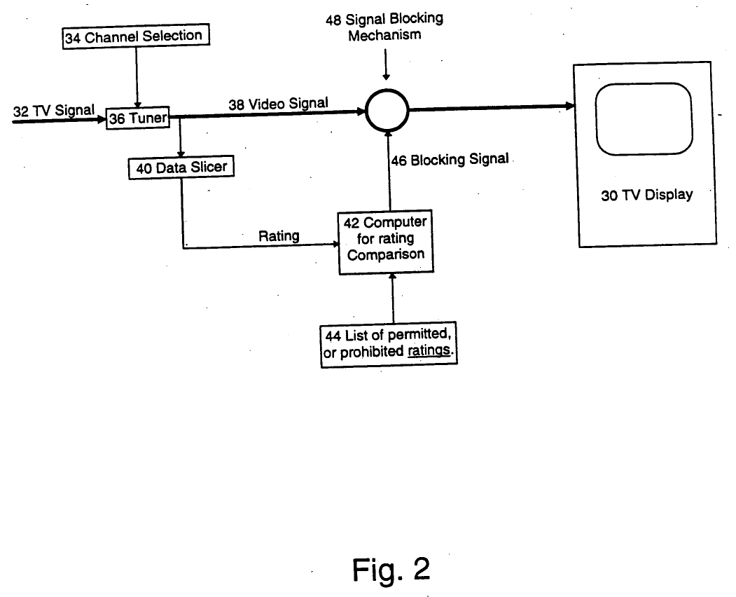

FIG. 3A is a schematic drawing of a preferred embodiment of a passive enforcement system constructed in accordance with the present invention;

FIG. 3B is a schematic drawing of an alternate embodiment of a passive enforcement system constructed in accordance with the present invention;

FIG. 4A is a flowchart showing a preferred method of selecting blocking or passing a program signal performed in the system of FIG. 3A;

FIG. 4B is a flowchart showing a preferred method of selecting blocking or passing a program signal performed in the system of FIG. 3B;

FIG. 5A is a menu system that allows a user to program the system of FIG. 3A with viewer specifications and associated content-based specifications.

FIG. 5B is a menu system that allows a user to program the system of FIG. 3B with viewer specifications and associated content-based and finite time range specifications;

FIG. 6 is a detailed depiction of a remote control unit used in conjunction with the menu systems of FIG. 5A and 5B;

FIG. 7 is a chart showing rating and subject matter categories.

### DETAILED DESCRIPTION OF THE PREFERRED EMBODIMENTS

The public has demanded that children be protected from questionable material on television, on the Internet, in movies, and in other media. However, because most blocking systems based on media ratings are active systems, a system administrator, such as the parent or other supervising adult, must continuously enable and disable the system with the use of digital codes. In contrast, the media rating enforcement system and method of the present invention is a passive system that incorporates a facial recognition system. The facial recognition system includes facial recognition software running on a computer or other CPU that may be incorporated in the media device or system being viewed. Coupled to the computer or CPU is a digital video camera that continually scans the viewing area and captures facial images of all persons within viewing distance of the media device or system being viewed such as a television, video monitor, movie screen, computer monitor, and the like. Whenever a face is recognized, a pre-established “viewing profile” for that individual contained in memory is examined by the enforcement system. If the rating of the current program exceeds the rating in the viewing profile, the system will block the program from view until that individual vacates the immediate viewing area such that the camera no longer scans the offending individual's face, even though there may be others in the room who are actually mature enough to watch the program. The system, however, can be overridden with a parental lock code or pass-code. Alternatively, the system may be programmed to disregard the presence of an offending individual if the system administrator (parental supervision) is in the viewing area.

The system may also be used to monitor viewing habits of persons within a given household. The system could store the names and/or faces of all of the individuals watching a program. Such information may be useful to parents interested in monitoring the viewing habits of their children, and in particular the content viewed and viewing time. In addition, this system may be used by media rating agencies, with the permission of the viewers, to gather statistics on what programs are watched, age and gender of each viewer, preferences of each viewer, and the like.

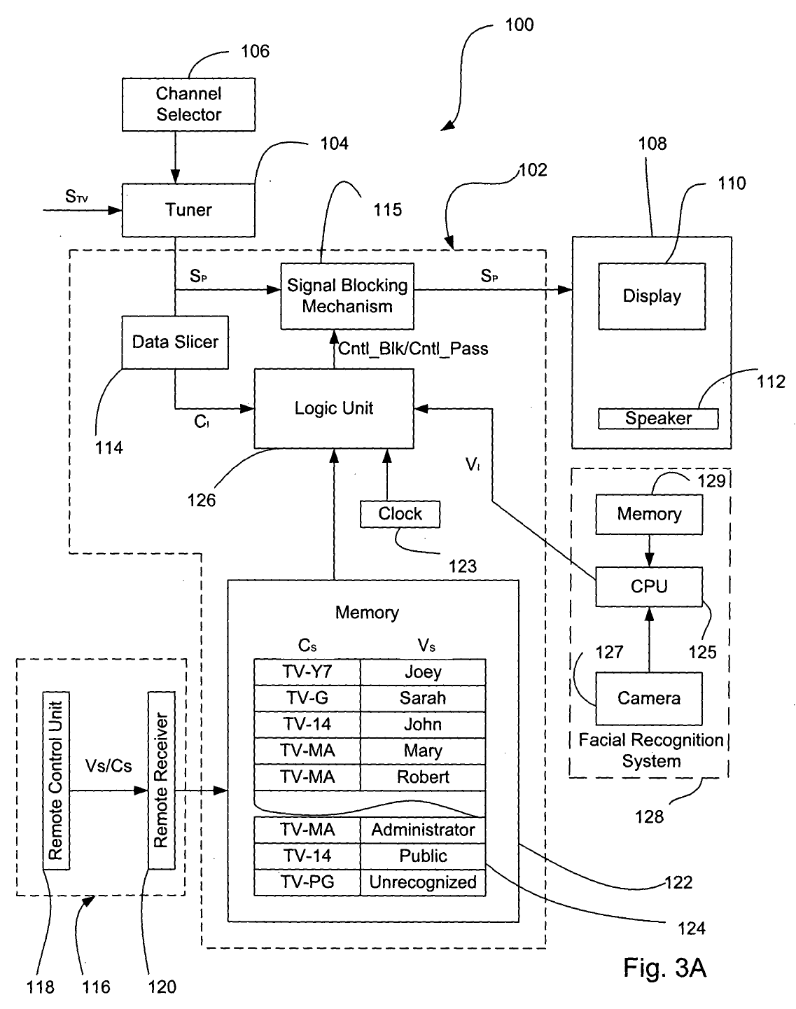

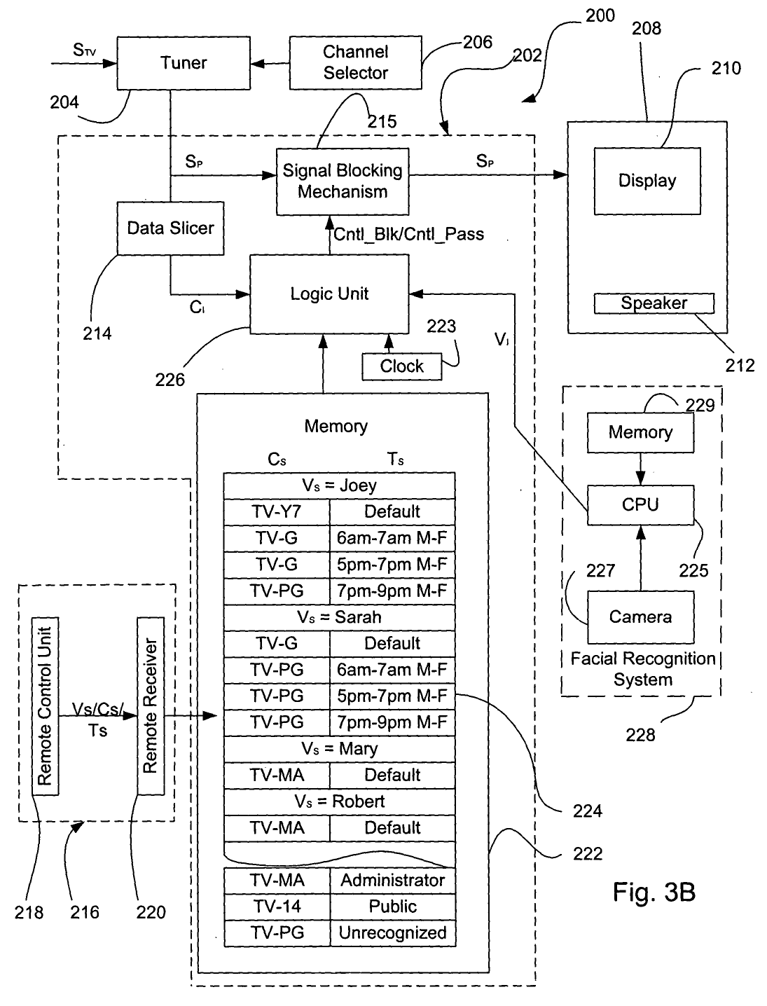

Turning to the figures, a detailed discussion of the media rating enforcement system and method of the present invention is provided. FIG. 3A shows a schematic representation of a consumer electronics system 100, and in particular a television system, constructed in accordance with a preferred embodiment of the present invention to include a passive media rating enforcement system. It should be noted that the consumer electronics system 100 is not to be limited to a television system, but can include any type of system that receives information that a parent might find objectionable, such as, e.g., a video cassette recorder (VCR), audio equipment and computer equipment. In general, the consumer electronic device receives a content signal that provides content to a viewer/user in the form of audio/visual informatioin. In regard to the television system 100, it receives a television program signal S_{TV}, and absent intervention, provides a program to a viewer in the form of audio/visual information. The television system 100 includes enforcement system circuitry 102, commonly referred to as the “V-chip”, that can be programmed by a user, such as, e.g., a parent, to selectively limit exposure of any programs to children that the user feels contain inappropriate subject matter. In particular, the “V-chip” circuitry 102 can be programmed to block the program signal S_{P} if the content of the program meets certain criteria selected by the user for a particular viewer present in the viewing area and identified by the facial recognition system 128.

In this connection, the television system 100 includes a tuner 104, which receives the television signal S_{TV}, and, under the control of a channel selector 106, provides a program signal S_{P} at an output. Typically, the television signal S_{TV} includes a broad range of program channels when received via an antenna or directly from cable entering the premises. It is often the case, however, that the television signal S_{TV} received by the tuner 104 has been pre-tuned, for example, through a cable box or video cassette recorder (VCR) (both not shown). The television system 100 further includes an audio/visual output device 108, which transforms the program signal S_{P} into the program in the form of a display on a display screen 110 and sound from a speaker 112.

The “V-chip” circuitry 102 of the television system 100 includes a signal blocking mechanism 115, which is coupled to the output of the tuner 104 to receive the program signal S_{P}. The signal blocking mechanism 115 is shown as a simple switch, but can be any mechanism that allows a signal to be selectively passed and/or blocked. Depending on the state of a control signal received by the signal blocking mechanism 115, the program signal S_{P} is either blocked from passing or allowed to pass to the audio/video output device 108. In alternative embodiments, the “V-chip” circuitry 102 includes a signal impairment device such as a signal scrambler, which either scrambles the program signal S_{P} or passes the program signal S_{P} to the audio/video output device 108 without impairment thereof.

In this particular embodiment, the program signal S_{P} not only includes information required to provide the program to the viewer, but also one or more content-based indicators C₁. The content-based indicators C₁ are indicative of the content of the program, and preferably include a rating, such as, e.g., a television or movie rating, or a rating and a subject matter category, such as, e.g., sex, violence or adult language, which is used to further restrict the rating. Presently, the Federal Communications Commission (FCC) dictates the following ratings and subject matter categories: television ratings shall include TV-Y, TV-Y7, TV-G, TV-PG, TV-14 and TV-MA; movie ratings include G, PG, PG-13, R, NC-17 and X; and the subject matter categories include FV (Fantasy Violence), D (Sexual Dialog), L (Adult Language), S (Sexual Situations) and V (Violence). It can be appreciated by those skilled in the art that the present invention is not limited to the above-disclosed ratings and categories, but can encompass any content-based indicator C₁ that provides information allowing an individual to determine the content of a particular program received by the television system 100.

The content-based indicators C₁ are incorporated into the program signal S_{P}, preferably using an extended data service (XDS or EDS) system. It can be appreciated by those skilled in the art that the content-based indicators C₁ can originate from any source dependent or independent of the program signal S_{P}. For instance, the content-based indicators C₁ can be supplied by the Program Status Information Protocol (PSIP) or an Electronic Program Guide (EPG). The “V-chip” circuitry 102 further includes a data extraction device 114, which is coupled to the output of the tuner 104 to receive the program signal S_{P}. In this embodiment, the data extraction device 114 is a closed caption data slicer, which monitors the program signal S_{P} and obtains from it XDS information, namely, the content-based indicators C₁.

A user entry system 116, typically embodied in a remote control unit 118 and a corresponding remote receiver 120, is the mechanism by which a user inputs one or more viewer specifications V_{S} and one or more content-based specifications C_{S} associated with the viewer specifications V_{S} to build and store viewing profiles. The one or more viewer specifications V_{S} are indicative of the viewers likely to be identified by the facial recognition system in the viewing area and, like the viewer indicators V₁, comprises a viewer's name, age or the like. The content-based specifications C_{S} are indicative of the content of any program that the user wishes to limit on a viewer basis and, like the content-based indicators C₁, the content-based specification C_{S} can be selected from a variety of content ratings and subject matter categories. The “V-chip” circuitry 102 includes non-volatile memory 122, which is coupled to the program entry system 116 for receiving and storing the viewer specifications V_{S} and associated content-based specifications C_{S} as viewing profiles in a look-up list 124. Preferably, the non-volatile memory 122 is embodied in Flash Memory or an EEPROM.

The “V-chip” circuitry 102 further includes a logic unit 126 to generate either a block control signal CTRL_{BLOCK}, which causes the signal blocking mechanism 115 to preclude the program signal S_{P} from being passed effectively to the audio/video output device 108, or a pass control signal CTRL_{PASS}, which permits the program signal S_{P} to be passed via the signal blocking mechanism 115 to the audio/video output device 108. In the preferred embodiment, the logic unit 126 is preferably implemented as a microprocessor. While an integrated device is preferable, any analog or digital system, discrete or integrated, or combinations thereof may be utilized if the functionalities of the invention may be achieved. For expository convenience, the logic unit 126 will be identified as a comparator, though the label comparator is not intended to exclude other logic combinations or functionalities.

The logic unit 126 is coupled to the output of the data slicer 114 to receive the extracted content-based indicators C₁, the non-volatile memory 122 to receive the viewer specifications V_{S} and associated content-based specifications C_{S}, and the facial recognition system 128 to receive viewer indicators V₁ indicative of the viewers present in the viewing area. The logic unit 126 compares the viewer indicators V₁ with the viewer specifications V_{S} to determine the active viewing profiles and the content-based indicators C₁ with the content-based specifications C_{S} of the active viewing profiles, and then generates a control signal CTRL in response thereto, which either constitutes a block control signal CTRL_{BLOCK} or a pass control signal CTRL_{PASS}. The lowest or least mature content-based specifications C_{S} associated with a viewer in the viewing area preferably dictates which control signal CTRL, i.e., a block control signal CTRL_{BLOCK} or a pass control signal CTRL_{PASS}, will be generated by the logic unit 126. The logic unit 126 is coupled to a clocking signal generating clock 123, which allows the control signal CTRL to be periodically updated, preferably, during every frame of the program signal S_{P} (about every 16 ms). The control signal CTRL can, however, be updated less frequently, e.g., every second or every minute.

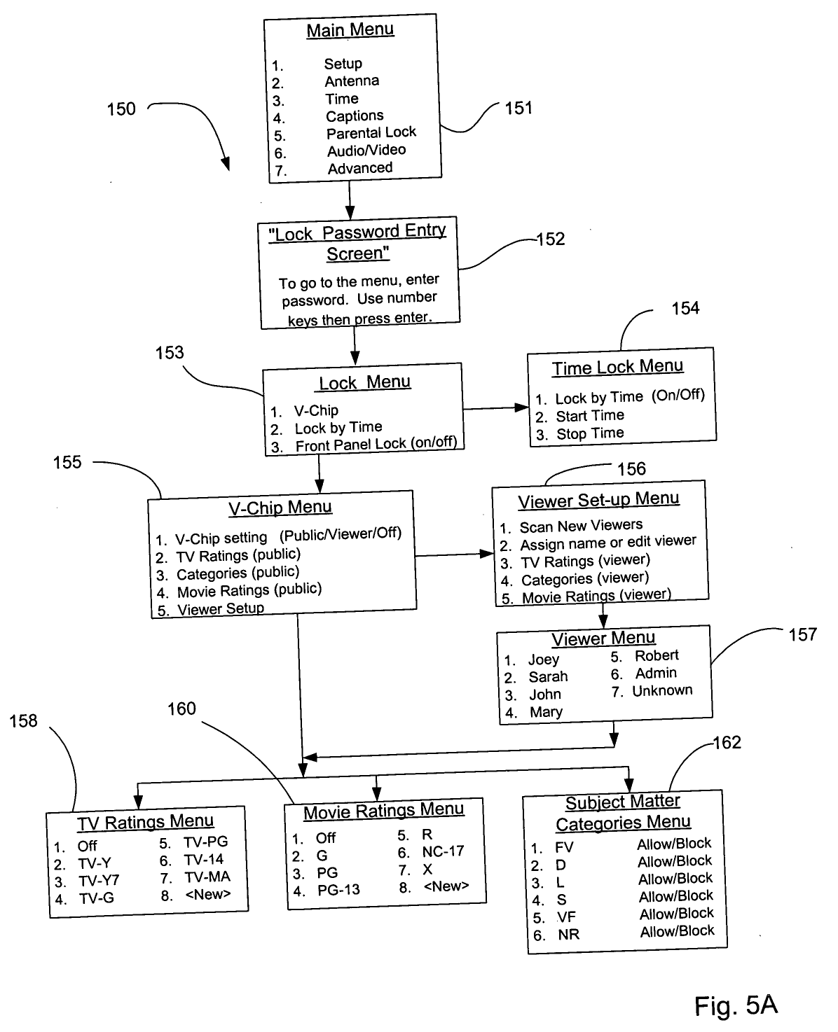

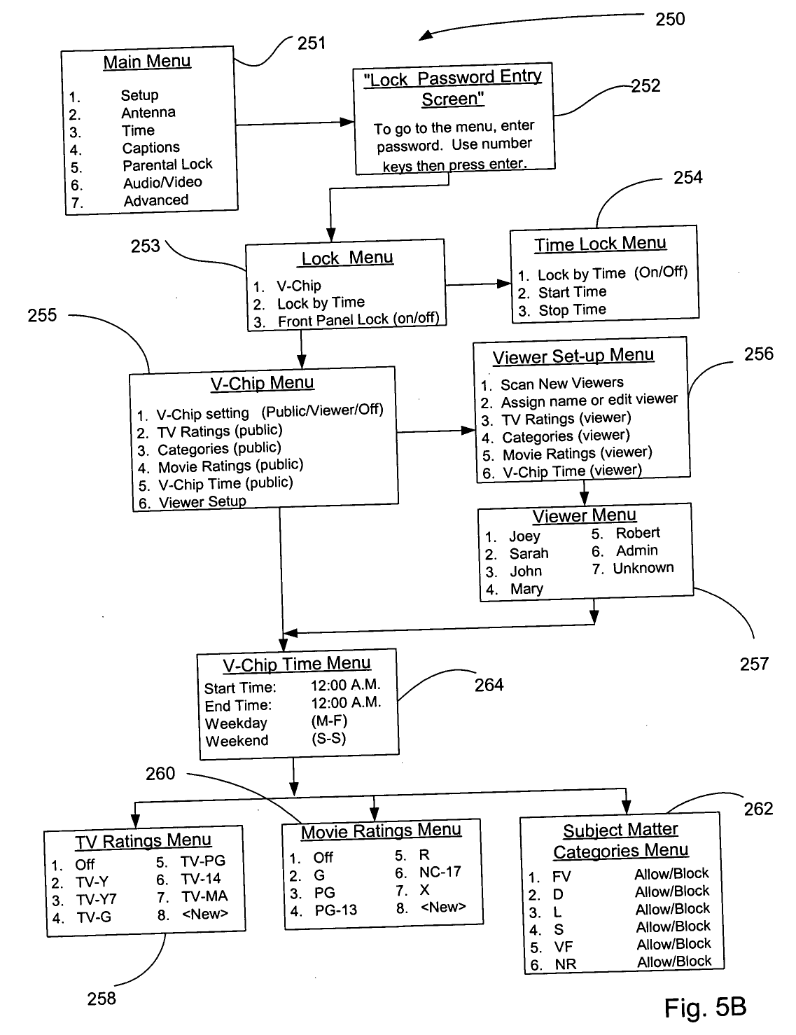

The facial recognition system 128 includes a digital video camera 127 coupled to a dedicated computer or CPU 125, or, in the alternative, a CPU of the viewing device. The CPU 125 preferably runs facial recognition software known in the art while the camera 127 continuously scans the entire viewing area associated with the television system 100. The facial recognition system 128 further comprises nonvolatile memory 129 used for storage of image libraries associated with individual viewers. Prior to implementation, all likely viewers, e.g., all members of a family, are photographed from several different angles by the system 128 using the digital video camera 127, or other digital camera from which the images can be downloaded into the memory 129 of the system 128. (see, e.g., the “SCAN NEW VIEWERS” selection of the “VIEWER SETUP” menu 156 of the menu system 150 in FIG. 5A). When stored, the digital images comprising the facial features of individual viewers are associated with an individual viewers name, age or the like. When the facial features are recognized by the system 128, viewer indicators V₁ are sent to the logic unit 126 of the enforcement circuitry 102. When not recognized, the facial features may trigger the transmission of a default viewer indicator such as “Unknown” to the logic unit 126, or trigger the system to prompt the user to update the viewer image and profile databases. Because facial features of selected viewers tend to change over time, the pre-implementation process of photographing selected viewers may be repeated on a periodic basis or, in the alternative, upon recognition of a viewer, the system 128 preferably updates the viewer profile database to include current facial features.

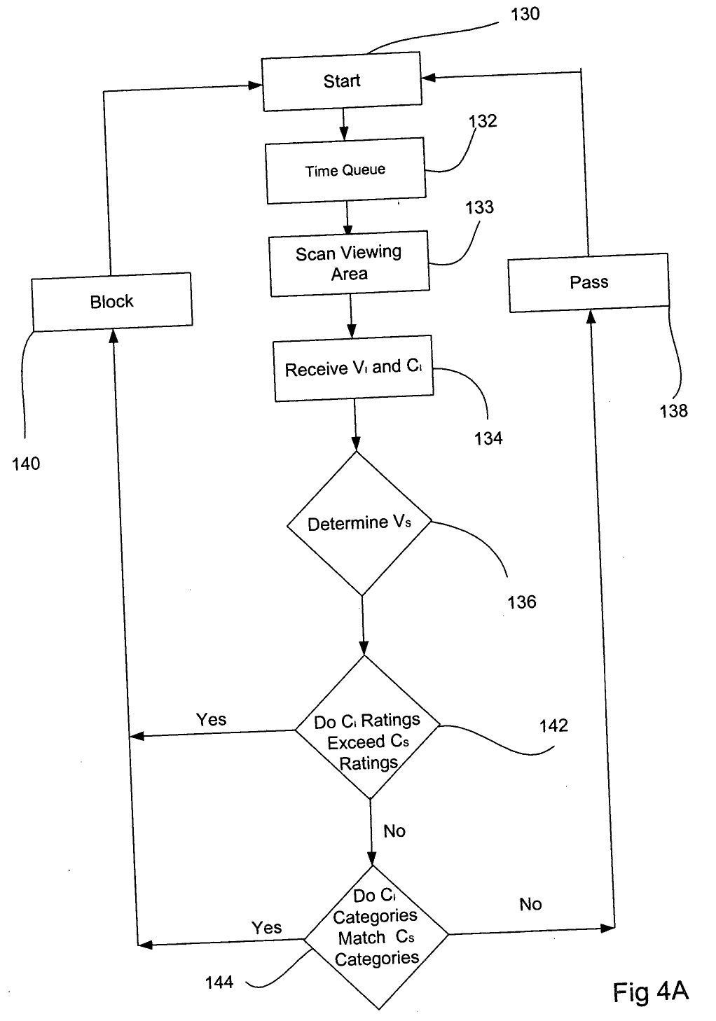

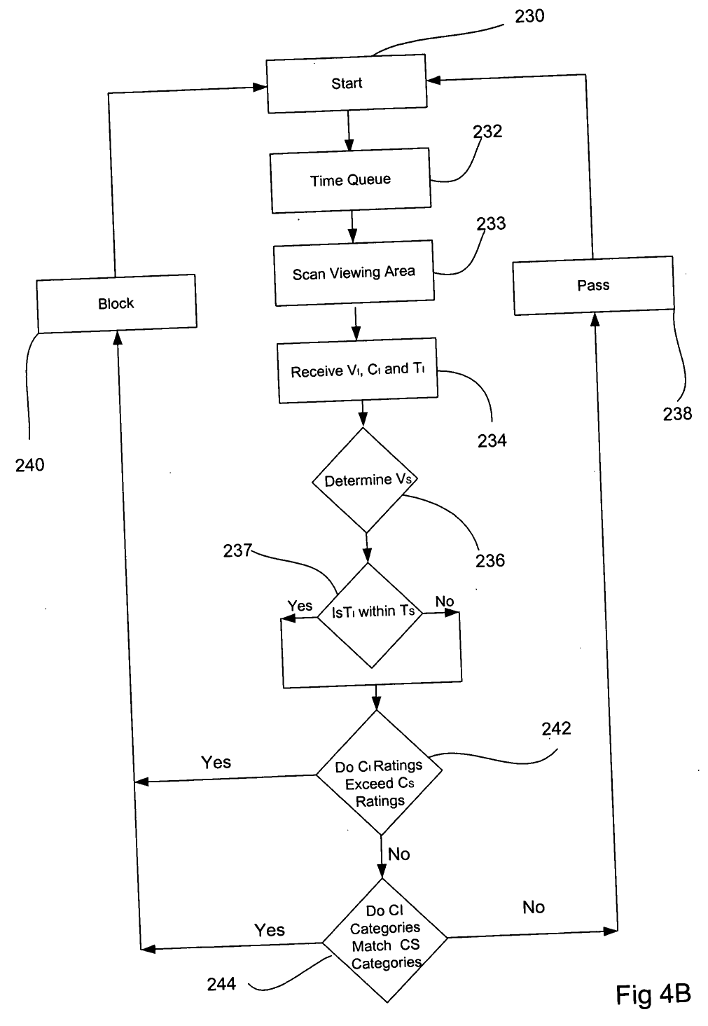

Referring to FIG. 4A, operation of the logic unit 126 is explained in further detail. At step 130, the control signal CTRL generated by the logic unit 126 either indicates BLOCK or PASS. When the control signal CTRL indicates BLOCK, the signal blocking mechanism 115 blocks the program signal S_{P} from being sent to the audio/video output device 108. For the purposes of the present invention, it should be understood that blocking the program signal S_{P} entails blocking at least one of the video, audio and captioning aspects of the program signal S_{P}. Preferably, however, all three of these aspects are blocked, such that the picture, sound and captioning will not be output from the audio/video output device 108. When the control signal CTRL indicates a PASS, the signal blocking mechanism 115 sends the program signal S_{P} to the audio/video output device 108, such that the picture, sound and captioning are output.

At step 132, the logic unit 126 waits for a time queue from the clock 123, and upon receipt of the time queue, the logic unit 126 determines, as follows, whether the “V-chip” circuitry 102 has been enabled while the facial recognition system 128, at step 133, scans the viewing area. In particular, the logic unit 126 receives, at step 134, the current viewer indicator(s) V₁ obtained from the facial recognition system 128 and the content-based indicators C₁ obtained from the program signal S_{P}. The logic unit 126 then determines, at step 136, which viewing profiles are active by comparing the viewer indicator(s) V₁ with the viewer specifications V_{S} from the look up list 124. Alternatively, the logic-unit 126 may ask when encountering a viewer indicator V₁ for an unknown or unrecognized viewer present in the viewing area whether the user would like to update the system databases. If the system administrator is present, the system administrator could update the system by entering the menu system discussed in regard to FIG. 5A.

With the active viewing profiles identified, wherein a viewer specification V_{S} corresponding to the viewer indicator V₁ is selected, the logic unit 126, at steps 142 and 144, analyzes the content-based indicators C₁ obtained from the program signal S_{P} vis-à-vis the content-based specifications C_{S} associated with the viewer specifications V_{S}. In the case of program ratings, if after comparing the content-based indicators C₁ with the content-based specifications C_{S} it is found that any of the content-based indicator C₁ ratings exceed any of the content-based specification C_{S} ratings (typically, there will be a maximum of two content-based specification C_{S} ratings—a television rating and a movie rating), the logic unit 126, at step 140, generates a block control signal CTRL_{BLOCK}, thereby enabling the “V-chip” circuitry 102 and blocking the program signal S_{P} to the audio/video output device 108. If the content-based indicators C₁ ratings do not exceed the ratings of the content-based specifications C_{S} associated with the viewer specifications V_{S}, the logic unit 126 goes to step 144 where it analyzes whether any of the subject matter categories of the content-based indicators C₁ match any of the subject matter categories of the content-based specifications C_{S} associated with the viewer specifications V_{S}.

If after comparing the categories of the content-based indicators C₁ with the categories of the content-based specifications C_{S} it is found that any of the content-based indicators C₁ categories match any of the categories of the content-based specifications C_{S} associated with the viewer specifications V_{S}, the logic unit 126, at step 140, generates a block control signal CTRL_{BLOCK}, thereby enabling the “V-chip” circuitry 102 and blocking the program signal S_{P} to the audio/video output device 108. If none of the categories of the content-based indicators C₁ match any of the categories of the content-based specifications C_{S} associated with the viewer specifications V_{S}, the logic unit 126, at step 138, generates a pass control signal CTRL_{PASS}, thereby disabling the “V-chip” circuitry 102 and passing the program signal S_{P} to the audio/video output device 108. The logic unit 126 then proceeds to step 130, where the analysis process is repeated. The logic unit 126 performs the aforementioned steps by executing instructions that preferably take the form of computer software stored in the memory 122 or other suitable storage medium, such as, e.g., a ROM chip, or fixed logic, such as, e.g., an ASIC. However, it should be appreciated that the logic unit 126 could be configured to generate a pass signal if any of the categories of the content-based indicators C₁ match any of the categories of the content-based specifications C_{S} and a block signal if there are no matches without straying from the principles taught by this invention.

Of course, the television system 100 may be configured, such that the “V-chip” circuitry 102 may be enabled or disabled independently from the viewer specifications V_{S}, and, as discussed in detail below, time range specifications T_{S}. For instance, the “V-chip” circuitry 102 may be optionally operated in a standard analysis, i.e., public, mode, whereby the “V-chip” circuitry 102 can be enabled to automatically analyze the content-based indicators C₁ vis-à-vis the content-based specifications C_{S} without regard to the viewer or time range, or disabled to automatically pass the program signal S_{P} to the audio/video output device 108.

Programming of the viewing profiles, i.e., the viewer specifications V_{S} and associated content-based specifications C_{S}, into the “V-chip” circuitry 102, and in particular the look-up list 124 of the non-volatile memory 122, is preferably effected through the use of a menu system 150, shown in FIG. 5A. As depicted, the menu system 150 includes an array of menus, which includes a main menu 151, a lock password entry screen 152, a “Lock” menu 153, a “Time Lock” menu 154, a “V-chip” main menu 155, a “Viewer Setup” menu 156, a “Viewer” menu 157, a television ratings menu 158, a movie ratings menu 160, and a subject matter categories menu 162.

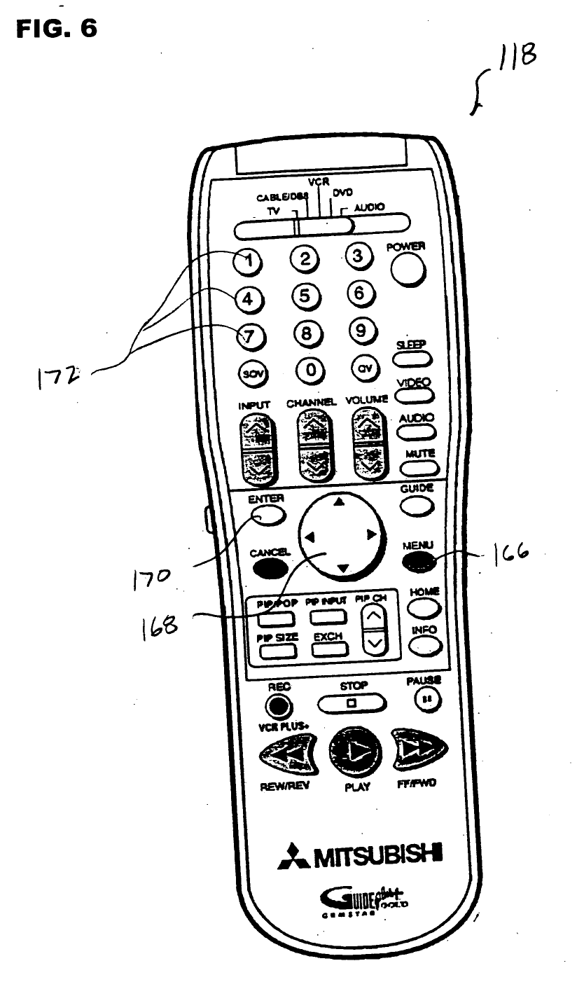

The user entry system 116, and in particular the remote control unit 118 (shown in detail in FIG. 6), preferably is the operative device through which the user can interact with the menu system 150. The remote control unit 118 includes a menu key 166, adjust thumb disc 168, enter key 170 and numeric keys 172 to allow the user to input selected information via the menu system 150. Depression of the menu key 166 displays the main menu 151 of the menu system 150 when the television system 100 is in a home state (i.e., normal operation of the television system 100). If the main menu 151 is displayed, subsequent depression of the menu key 166 returns the user back to the home state. If one of the submenus is displayed, depression of the menu key 166 displays the previous menu. The adjust thumb disc 168 allows the user to scroll up, down, left or right within the menu system 150 to select a particular menu item. Depression of the enter key 170 allows the user to select a sub-menu or to enter a selected menu item into the non-volatile memory 122.

Within the main menu 151, the user may select the “Parental Lock” menu item, which takes the user to the “Lock Password Entry Screen” 152. A password, preferably known only by the parents (adminstrator), is entered via the numeric keys 172. If the correct password is entered, the user is taken to the “Lock” menu 153. If an incorrect password is entered, the user is not taken to the “Lock” menu 153, and the words “try again” are displayed. In the “Lock” menu 153, the user can select the “V-Chip” selection to configure or disable the “V-chip” circuitry 102, the “Lock by Time” selection to alternatively enable or disable a complete lock of the TV based on the time of day, and the “Front Panel Lock” selection to alternatively enable or disable a lock of the front control panel of the TV. If the user selects “V-Chip”, the user is taken to the “V-Chip” menu and can then select “Viewer” or “Public” to enable the “V-chip” circuitry 102 to analyze the program signal with (viewer mode) or without (public mode) regard to individual viewers, or “Off” to disable the “V-chip” circuitry 102.

If “Public” is selected, the “V-chip” menu 155 can also be used to select the type of content-based specification C_{S} to be entered into the look-up list 124 and associated with a public viewer specification V_{S} to establish a viewing profile for all potential viewers. If “Viewer” is selected, the user can then select “Viewer Setup” in the “V-Chip” menu 155 to be taken to the “Viewer Setup” menu 156. In the “Viewer Setup” menu 156 the user can select “Scan Viewers” to use the facial recognition system 128 to photograph and enter new viewers into the system. The “Viewer Setup” menu 156 can also be used to select the type of content-based specification C_{S} to be entered into the look-up list 124 and associated with a viewer specification V_{S} to establish a viewing profile for a selected viewer. In establishing viewer profiles (public or individual viewers), the user can select TV RATINGS, MOVIE RATINGS, or CATEGORIES, to take the user respectively to the television ratings menu 158, movie ratings menu 160, or subject matter categories menu 162. Preferably, with regard to viewer mode, the menu system 150 requires the user to first select a viewer specification V_{S} from the viewer menu 157, and then a content-based specification C_{S} associated with the selected viewer specification V_{S}. However, it should be appreciated that the menu system 150 can be configured to require selection of the content-based specification C_{S} followed by selection of the viewer specification V_{S} without straying from the principles taught by this invention.

Within the television ratings menu 158, the user can select a particular movie rating, which prevents any program exceeding the selected television rating from being output from the audio/video output device 108. The television ratings can be selected from the following: OFF, TV-Y, TV-Y7, TV-G, TV-PG, TV-14 and TV-MA. A selection of OFF removes the previously selected content-based specification C_{S} television rating corresponding to the selected viewer specification V_{S} from the look-up list 124. A selection of any of the television ratings stores the selected television rating, as a content-based specification C_{S} associated with the selected viewer specification V_{S}, in the look-up list 124. Since a selection of a particular rating is effectively also a selection of all ratings below the selected rating, a selection of TV-MA is effectively the same as selecting OFF. As will be described in further detail below, however, selection of TV-MA affects the selection of the subject matter categories.

Within the movie ratings menu 160, the user can select a particular movie rating, which prevents any program exceeding the selected movie rating from being output from the audio/video output device 108. The movie ratings can be selected from the following: OFF, G, PG, PG-13, R, NC-17 and X. A selection of OFF removes the previously selected content-based specification C_{S} movie rating corresponding to the selected viewer specification from the look-up list 124. A selection of any of the movie ratings stores the selected movie rating, as a content-based specification C_{S} associated with the selected viewer specification V_{S}, in the look-up list 124. Selection of X is effectively the same as selecting OFF.

Within the subject matter categories menu 162, the user can select either to allow or block any program from being sent to the audio/video output device 108 when the program contains subject matter falling within the selected subject matter category. The subject matter categories can be selected from the following: FV (Fantasy Violence), D (Sexual Dialog), L (Adult Language), S (Sexual Situations), V (Violence) and Non-Rated Programs. A selection to allow a particular category, removes the content-based specification C_{S} corresponding to that category associated with the selected viewer specification V_{S} from the look-up list 124. Conversely, a selection to block a particular category stores the selected category, as a content-based specification C_{S} associated with the selected viewer specification V_{S}, in the look-up list 124.

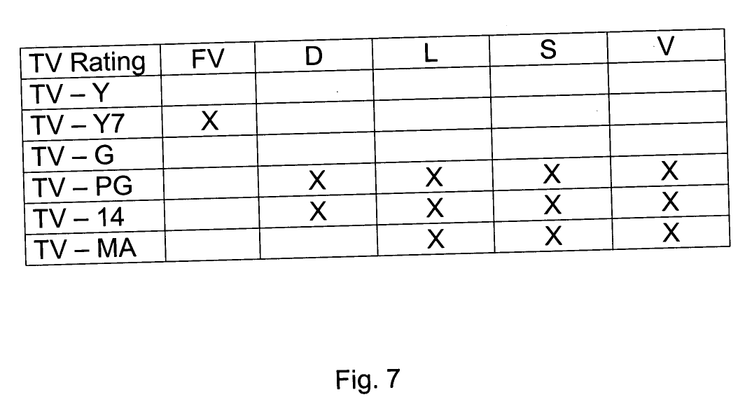

As currently dictated by the FCC, certain subject matter categories can be selected only if certain television ratings have been selected. For instance, category FV can only be selected if TV-Y7 has been selected. Category D can only be selected if TV-PG or TV-14 has been selected. Categories L, S and V can only be selected if TV-PG, TV-14 or TV-MA has been selected. Thus, the selection of categories enhances the television rating selected by the user. For instance, if television rating TV-14 and category S is selectively allowed, then all programs rated TV-MA are blocked and all programs containing sexual situations are blocked. Thus, the discretionary aspect of a selected television rating can be supplemented by further selecting a subject matter category. As can be appreciated any permeation of ratings and subject matter category may be used as a result. For example, (see FIG. 7) the following combinatory content-based specifications C_{S} can be created: TV-Y7 FV, TV-PG D, TV-PG L, TV-PG S, TV-PG V, TV-14 D, TV-14 L, TV-14 S, TV-14 V, TV-MA L, TV-MA S, TV-MA V, TV-PGDS, TV-PGDL, TV-PGDV, TV-PGDLS, TV-PGDSV, TV-PGDLV, TV-PGDLSV, TV-14DS, TV-14DL, TV-14DV, TV-14DLS, TV-14DSV, TV-14DLV, TV-14 DLSV, TV-MALS, TV-MASV, TV-MALV, TV-MALSV, etc. Some programs, such as, e.g., news and sports, are not rated or are un-rated. In this case, the user can select to allow all non-rated programs or block all non-rated programs. If the TV rating is OFF, non-rated programs cannot be selected.

Turning to the FIGS. 3B, 4B and 5B, a detailed discussion of an alternate embodiment of the media rating enforcement system and method of the present invention is provided. FIG. 3B shows a schematic representation of a consumer electronics system 200 that is substantially the same as the consumer electronics system 100 shown in FIG. 3A with the exception of the inclusion of time range specifications T_{S} listed in the look up list 224 of the non-volatile memory 222. As with the consumer electronics system 100 shown in FIG. 3A, the consumer electronics system 200 is not to be limited to a television system, but can include any type of system that receives information that a parent might find objectionable, such as, e.g., a video cassette recorder (VCR), audio equipment and computer equipment. In general, the television system 200 receives a television program signal S_{TV}, and absent intervention, provides a program to a viewer in the form of audio/visual information. The television system 200 includes “V-chip” circuitry 202 that can be programmed by a user, such as, e.g., a parent, to selectively limit exposure of any programs to children that the user feels contain inappropriate subject matter. In particular, the “V-chip” circuitry 202 can be programmed to block the program signal S_{P} if the content and time of the program meet certain criteria selected by the user for a particular viewer present in the viewing area and identified by a facial recognition 228.

In this connection, the television system 200 includes a tuner 204, which receives the television signal S_{TV}, and, under the control of a channel selector 206, provides a program signal S_{P} at an output. The television system 200 further includes an audio/visual output device 208, which transforms the program signal S_{P} into the program in the form of a display on a display screen 210 and sound from a speaker 212.

The “V-chip” circuitry 202 of the television system 200 includes a signal blocking mechanism 215, which is coupled to the output of the tuner 204 to receive the program signal S_{P} and to selectively pass and block the program signal S_{P}, or, in the alternative, pass and scramble the program signal S_{P}. In this particular embodiment, the program signal S_{P} not only includes information required to provide the program to the viewer and one or more content-based indicators C₁, but also timing information T₁. The timing information T₁ indicates a reference time, such as, e.g., the current time.

The content-based indicators C₁ and timing information T₁ are incorporated into the program signal S_{P}, preferably using an extended data service (XDS or EDS) system. It can be appreciated by those skilled in the art that the content-based indicators C₁ and timing information T₁ can originate from any source dependent or independent of the program signal S_{P}. For instance, the content-based indicators C₁ and timing information T₁ can be supplied by the Program Status Information Protocol (PSIP) or an Electronic Program Guide (EPG). The timing information T₁ can also originate from within the television system 200 via a user setting. The “V-chip” circuitry 202 further includes a data extraction device 214, which is coupled to output of the tuner 204 to receive the program signal S_{P} and obtain from it XDS information, namely, the content-based indicators C₁ and the timing information T₁.

A user entry system 216, typically embodied in a remote control unit 218 and a corresponding remote receiver 220, is the mechanism by which a user inputs one or more viewer specifications V_{S}, one or more finite time range specifications T_{S} and one or more content-based specifications C_{S} associated with the viewer specifications V_{S} and finite time range specifications T_{S}. The finite time range specifications T_{S} are the time ranges during which the user wishes to limit the content of any program in relation to a particular viewer. The “V-chip” circuitry 202 includes non-volatile memory 222, which is coupled to the program entry system 216 for receiving and storing the viewer specifications V_{S} and associated content-based specifications C_{S} and finite time range specifications T_{S} as viewing profiles in a look-up list 224. Preferably, the non-volatile memory 222 is embodied in Flash Memory or an EEPROM.

The “V-chip” circuitry 202 further includes a logic unit 226 to generate either a block control signal CTRL_{BLOCK}, which causes the signal blocking mechanism 215 to preclude the program signal S_{P} from being passed effectively to the audio/video output device 208, or a pass control signal CTRL_{PASS}, which permits the program signal S_{P} to be passed via the signal blocking mechanism 215 to the audio/video output device 208. The logic unit 226 is coupled to the output of the data slicer 214 to receive the extracted content-based indicators C₁ and the current time T₁, the non-volatile memory 222 to receive the viewer specifications V_{S}, finite time range specifications T_{S} and associated content-based specifications C_{S} and the facial recognition system 228 to receive viewer indicators V₁ indicative of the viewers present in the viewing area. The logic unit 226 compares the viewer indicators V₁ with the viewer specifications V_{S} to determine the active viewing profiles, the current time T₁ falls with the associated finite time range specifications T_{S} of the active viewing profiles to determine the active finite time range specifications T_{S}, then the content-based indicators C₁ with the content-based specifications C_{S} of the active viewing profile associated with the active time range specifications T_{S}, and generates a control signal CTRL in response thereto, which either constitutes a block control signal CTRL_{BLOCK} or a pass control signal CTRL_{PASS}. The logic unit 226 is coupled to a clocking signal clock, which allows the control signal CTRL to be periodically updated.

The facial recognition system 228 includes a digital video camera 227 coupled to a dedicated computer or CPU 225, or, in the alternative, a CPU of the viewing device. The CPU 225 preferably runs facial recognition software known in the art while the camera 227 continuously scans the entire viewing area associated with the television system 200. The facial recognition system 228 further comprises nonvolatile memory 229 used for storage of image libraries associated with individual viewers. Prior to implementation, all likely viewers, e.g., all members of a family, are photographed from several different angles by the system 228 using the digital video camera 227, or other digital camera from which the images can be downloaded into the memory 229 of the system 228. When stored, the digital images comprising the facial features of individual viewers are associated with an individual viewers name, age or the like. When the facial features are recognized by the system 228, viewer indicators V₁ are sent to the logic unit 226 of the enforcement circuitry 202. When not recognized, the facial features may trigger the transmission of a “default” viewer indicator such as “UNKNOWN” to the logic unit 226, or trigger the system to prompt the user to update the viewer image and profile databases.

Referring to FIG. 4B, operation of the logic unit 226 is explained in further detail. At step 230, the control signal CTRL generated by the logic unit 226 either indicates BLOCK or PASS. At step 232, the logic unit 226 waits for a time queue from the clock signal clock 223, and upon receipt of the time queue, the logic unit 226 determines, as follows, whether the “V-chip” circuitry 202 has been enabled while the facial recognition system 228, at step 233, scans the viewing area. In particular, the logic unit 226 receives, at step 234, the current viewer indicator(s) V₁ obtained from the facial recognition system 228 at step 233, the viewer specifications V_{S} obtained from the look-up list 224, the current time T₁ obtained from the program signal S_{P} and the current content-based indicator C₁ obtained from the program signal S_{P}. The logic unit 226 then determines, at step 236, which viewing profiles are active by comparing the viewer indicator(s) V₁ with the viewer specifications V_{S}.

With the active viewing profiles identified, wherein a viewer specification V_{S} corresponding to the viewer indicator V₁ is selected, the logic unit 226 then determines, at step 237, which time range specifications T_{S} are active by comparing the current time T₁ with any of the selected time range specifications T_{S}. Dependent on whether the current time T₁ does or does not fall within any of the selected time range specifications T_{S}, the logic unit 226, at step 242, analyzes the content-based indicators C₁ obtained from the program signal S_{P} vis-à-vis default content-based specifications C_{S} associated with the viewer specifications V_{S} for all times not within selected finite time range specifications T_{S} or vis-à-vis content-based specifications C_{S} associated with the viewer specifications V_{S} and selected time range specifications T_{S}. In the case of program ratings, if after comparing the content-based indicator C₁ with the content-based specification C_{S} it is determined that any of the content-based indicators C₁ ratings are determined to exceed any of the content-based specification C_{S} ratings (typically, there will be a maximum of two content-based specification C_{S} ratings—a television rating and a movie rating), the logic unit 226, at step 240, generates a block control signal CTRL_{BLOCK}, thereby enabling the “V chip” circuitry 202 and blocking the program signal S_{P} to the audio/video output device 208. If the ratings of the content-based indicators C₁ do not exceed the any of the ratings of the default content-based specifications C_{S} associated with the viewer specifications V_{S} and do not exceed any of the content-based specifications C_{S} associated with the viewer specifications V_{S} and selected time range specifications T_{S}, the logic unit 226 goes to step 244 where it analyzes whether any of the content-based indicators C₁ match any of the default content-based specifications C_{S} associated with the viewer specifications V_{S} and match any of the content-based specifications C_{S} associated with the viewer specifications V_{S} and determined time range specifications T_{S}.

If after comparing the content-based indicators C₁ with the content-based specifications C_{S} it is determined that any of the ratings of the content-based indicators C₁ match any of the default content-based specifications C_{S} associated with the viewer specifications V_{S} or match any of the ratings of the content-based specifications C_{S} associated with the viewer specifications V_{S} and determined time range specifications T_{S}, the logic unit 226, at step 240, generates a block control signal CTRL_{BLOCK}, thereby enabling the “V-chip” circuitry 202 and blocking the program signal S_{P} to the audio/video output device 208. If none of the content-based indicators C₁ match any of the default content-based specifications C_{S} associated with the viewer specifications V_{S} or match any of the content-based specifications C_{S} associated with the viewer specifications V_{S} and determined time range specifications T_{S}, the logic unit 226, at step 238, generates a pass control signal CTRL_{PASS}, thereby disabling the “V-chip” circuitry 202 and passing the program signal S_{P} to the audio/video output device 208. The logic unit 226 then proceeds to step 230, where the analysis process is repeated. However, it should be appreciated that the system 202 could be configured such that the logic unit 226, at step 238, generates a pass control signal CTRL_{PASS}, thereby disabling the “V-chip” circuitry 202 and passing the program signal S_{P} to the audio/video output device 208 when the logic unit 226, at step 242, determines that content-based indicators C₁ do not exceed any of the content-based specifications C_{S} without straying from the principles taught by this invention. It should also be appreciated that the logic unit 126 could be configured to generate a pass signal if any of the categories of the content-based indicators C₁ match any of the categories of the content-based specifications C_{S} and a block signal if there are no matches without straying from the principles taught by this invention.

Programming of the viewing profiles, i.e., the viewer specifications V_{S} and associated content-based specifications C_{S} and finite time range specifications T_{S} into the “V-chip” circuitry 202, and in particular the look-up list 224 of the non-volatile memory 222, is preferably effected through the use of a menu system 250, shown in FIG. 5B. As depicted, the menu system 250 includes an array of menus, which includes a main menu 251, a lock password entry screen 252, a “Lock” menu 253, a “Time Lock” menu 254, a “V-chip” main menu 255, a “Viewer Setup” menu 256, a “Viewer” menu 257, a television ratings menu 258, a movie ratings menu 260, and a subject matter categories menu 262, and a “V-Chip Time” menu 264.

The user entry system 216, and in particular the remote control unit 218 (shown in detail in FIG. 6), preferably is the operative device through which the user can interact with the menu system 250. Within the main menu 251, the user may select the “Parental Lock” menu item, which takes the user to the “Lock Password Entry Screen” 252. A password, preferably known only by the parents (adminstrator), is entered via the numeric keys 172. If the correct password is entered, the user is taken to the “Lock” menu 253. If an incorrect password is entered, the user is not taken to the “Lock” menu 253, and the words “try again” are displayed. In the “Lock” menu 253, the user can select the “V-Chip” selection to configure or disable the “V-chip” circuitry 202, the “Lock by Time” selection to alternatively enable or disable a complete lock of the TV based on the time of day, and the “Front Panel Lock” selection to alternatively enable or disable a lock of the front control panel of the TV. If the user selects “V-Chip”, the user is taken to the “V-Chip” menu and can then select “Viewer” or “Public” to enable the “V-chip” circuitry 202 to analyze the program signal with (viewer mode) or without (public mode) regard to individual viewers, or “Off” to disable the “V-chip” circuitry 202.

If “Public” is selected, the “V-chip” menu 255can also be used to select the type of content-based specification C_{S} and time range specifications T_{S} to be entered into the look-up list 224 and associated with a public viewer specification V_{S} to establish a public viewing profile for all potential viewers. If “Viewer” is selected, the user can then select “Viewer Setup” in the “V-Chip” menu 255 to be taken to the “Viewer Setup” menu 256. In the “Viewer Setup” menu 256 the user can select “Scan Viewers” to use the facial recognition system 228 to photograph and enter new viewers into the system. The “Viewer Setup” menu 256 can also be used to select the type of content-based specification C_{S} and time range specifications T_{S} to be entered into the look-up list 224 and associated with a viewer specification V_{S} to establish a viewing profile for a selected viewer. In establishing viewer profiles (public or individual viewers), the user can select TV RATINGS, MOVIE RATINGS, or CATEGORIES, to take the user respectively to the television ratings menu 258, movie ratings menu 260, or subject matter categories menu 262. Preferably, with regard to viewer mode, the menu system 250 requires the user to first select a viewer specification V_{S} from the viewer menu 257, and then content-based specification C_{S} associated with the selected viewer specification V_{S} and time range specifications T_{S} from the time range menu 264 associated with the selected content-based specification C_{S} and viewer specification V_{S} from the time range menu 264. However, it should be appreciated that the menu system 250 can be configured to require selection of the time range specification T_{S} followed by selection of the content-based specification C_{S} and viewer specification V_{S} without straying from the principles taught by this invention.

Within the television ratings menu 258, the user can select a particular movie rating, which prevents any program exceeding or, in the alternative, matching or exceeding, the selected television rating from being output from the audio/video output device 208. The television ratings can be selected from the following: OFF, TV-Y, TV-Y7, TV-G, TV-PG, TV-14 and TV-MA. A selection of OFF removes the previously selected content-based specification C_{S} television rating and time range(s) corresponding to the selected viewer specification V_{S} from the look-up list 224. A selection of any of the television ratings stores the selected television rating, as a content-based specification C_{S}, in the look-up list 224. Since a selection of a particular rating is effectively also a selection of all ratings below the selected rating, a selection of TV-MA is effectively the same as selecting OFF. As will be described in further detail below, however, selection of TV-MA affects the selection of the subject matter categories.

Within the movie ratings menu 260, the user can select a particular television rating, which prevents any program exceeding or, in the alternative, matching or exceeding, the selected movie rating from being output from the audio/video output device 208. The movie ratings can be selected from the following: OFF, G, PG, PG-13, R, NC-17 and X. A selection of OFF removes the previously selected content-based specification C_{S} movie rating and time range(s) corresponding to the selected viewer specification V_{S} from the look-up list 224. A selection of any of the movie ratings stores the selected movie rating, as a content-based specification C_{S}, in the look-up list 224. Selection of X is effectively the same as selecting OFF.

Within the subject matter categories menu 262, the user can select either to allow or block any program from being sent to the audio/video output device 208 when the program contains subject matter falling within the selected subject matter category. The subject matter categories can be selected from the following: FV (Fantasy Violence), D (Sexual Dialog), L (Adult Language), S (Sexual Situations), V (Violence) and Non-Rated Programs. A selection to allow a particular category, removes the content-based specification C_{S} corresponding to that category from the look-up list 224. Conversely, a selection to block a particular category stores the selected category, as a content-based specification C_{S}, in the look-up list 224.

After a particular content-based specification C_{S} is selected, the user is brought to the “V-Chip Time” range menu 264 wherein the user can define one or more time range specifications T_{S} to be associated with the selected content-based specification C_{S}. The time range specification T_{S} can be defined by entering a time into the START TIME entry and entering a time into the STOP TIME entry. The defined time range specification T_{S} is then entered in the look-up list 224. Another time range specification T_{S} associated with the selected content-based specification C_{S} can be defined by again entering times into the START TIME and STOP TIME entries. If the START and STOP TIMES are the same, the time range will be a 24 hour period. Preferably, the time range specification T_{S} defined can be applied to each work day of the week (M-F) or to the weekends. This can be accomplished by selecting either the WEEKDAY (M-F) or the WEEKEND (S-S) after selection of the time range.

While preferred methods and embodiments have been shown and described, it will be apparent to one of ordinary skill in the art that numerous alterations may be made without departing from the spirit or scope of the invention. Therefore, the invention is not to be limited except in accordance with the following claims.

1. A consumer electronics device having media supervision enforcement circuitry for supervising personal exposure to user discernible information, comprising:
a first logic unit configured for generating viewer indicators indicative of viewers present in a viewing area;
non-volatile memory configured for receiving viewing profiles for selected viewers;
a second logic unit coupled to the first logic unit and the non-volatile memory and being configured for comparing a viewer indicator with viewing profiles to identify an active viewing profile and a content-based indicator with the active viewing profile, the second logic unit being further configured for generating a control signal in response to the comparison between the content-based indicator and the viewing profiles; and
a signal impairment mechanism coupled to the logic unit and configured for, based on the control signal, selectively passing a program signal therethrough without substantial impairment or passing the program signal therethrough with substantial impairment.

2. The consumer electronics device of claim 1 wherein each of the viewing profiles comprises a viewer specification and a content-based specification corresponding to the viewer specification;

3. The consumer electronics device of claim 2, further comprising an output device coupled to the signal impairment mechanism for transforming the program signal into the user discernible information.

4. The consumer electronics device of claim 1, further comprising a data entry system for selectively inputting the viewer and content-based specifications into the non-volatile memory for storage.

5. The consumer electronics device of claim 1, wherein the non-volatile memory includes a look-up list for storing a plurality of viewer specification and associated content-based specifications.

6. The consumer electronics device of claim 1, wherein the program signal carries the content-based indicator, and further comprising a data extraction device coupled to the logic unit for extracting the content-based indicator.

7. The consumer electronics device of claim 1, wherein the signal impairment device is a switch.

8. The consumer electronics device of claim 1, wherein the output device is a television system audio/video output device.

9. The consumer electronics device of claim 1, wherein the first logic unit is a computer configured to run facial recognition software.

10. The consumer electronics device of claim 1, further comprising a camera coupled to the first logic unit and configured to continuously scan the viewing area associated with the consumer electronic device.

11. The consumer electronics device of claim 1 wherein each of the viewing profiles comprises a viewer specification, a finite time range specification and a content-based specification corresponding to the viewer and time range specifications.

12. The consumer electronics device of claim 1, further comprising a data entry system for selectively inputting the viewer, time range and content-based specifications into the non-volatile memory for storage.

13. The consumer electronics device of claim 1, wherein the non-volatile memory includes a look-up list for storing a plurality of viewer specification and associated time range and content-based specifications.

14. The consumer electronics device of claim 1, wherein the program signal carries the content-based indicator and timing information, and further comprising a data extraction device coupled to the logic unit for extracting the content-based indicator and timing information.

15. A recordable medium comprising:
a computer program comprising steps for:
receiving a program signal suitable for conversion by a consumer electronics device into user discernible information;
receiving a content-based indicator indicative of the content of the user discernible information;
receiving a viewer indicator indicative of a viewer present in a viewer area;
selecting a viewer specification associated with the viewer indicator;
selecting a content-based specification associated with the selected viewer specification;
comparing the selected content-based specification with received content-based indicator; and
generating a control signal based on the comparison between the selected content-based specification and the received content-based indicator.

16. The recordable medium of claim 15, wherein each of the received content-based indicator and the selected content-based specification is a rating.

17. The recordable medium of claim 16, wherein the control signal is generated if the received content-based rating exceeds the selected content-based rating.

18. The recordable medium of claim 15, wherein each of the received content-based indicators and the selected content-based specifications is a subject matter category.

19. The recordable medium of claim 18, wherein the control signal is generated if the received content-based category matches the selected content-based category.

20. The recordable medium of claim 15, wherein the control signal is generated to impair the program signal.

21. The recordable medium of claim 15, wherein the computer program further comprises the steps of
receiving timing information indicative of a reference time;
selecting a finite time range specification associated with the timing information;
selecting a content-based specification associated with the selected viewer and time range specifications.

22. A device having comprising:
a viewer monitoring system;
non-volatile memory for receiving viewing profiles of selected viewers;
a logic unit coupled to the viewer monitoring system and the non-volatile memory and being configured for comparing a viewer indicator with viewing profiles to identify an active viewing profile and a content-based indicator with the active viewing profile, the logic unit being further configured for generating a control signal in response to the comparison between the content-based indicator and the viewing profiles; and
a signal impairment mechanism coupled to the logic unit and configured for, based on the control signal, selectively passing a program signal therethrough without substantial impairment or passing the program signal therethrough with substantial impairment.

23. The device of claim 22 wherein the viewer monitoring system comprising a facial recognition system.

24. The device of claim 23 wherein the facial recognition system comprises a computer configured to run a facial recognition program and a camera coupled to the computer.

25. The device of claim 22 wherein each of the viewing profiles comprises a viewer specification and a content-based specification corresponding to the viewer specification.

26. The device of claim 22, further comprising an output device coupled to the signal impairment mechanism for transforming the program signal into the user discernible information.

27. The device of claim 22, further comprising a data entry system for selectively inputting the viewer and content-based specifications into the non-volatile memory for storage.

28. The device of claim 22, wherein the non-volatile memory includes a look-up list for storing a plurality of viewer specifications and associated content-based specifications.

29. The consumer electronics device of claim 22, wherein the program signal carries the content-based indicator, and further comprising a data extraction device coupled to the logic unit for extracting the content-based indicator.

30. The consumer electronics device of claim 22, wherein the signal impairment device is a switch.

31. The consumer electronics device of claim 22, wherein the output device is a television system audio/video output device.

32. The consumer electronics device of claim 22 wherein each of the viewing profiles comprises a viewer specification, a finite time range specification and a content-based specification corresponding to the viewer and time range specifications.

33. The consumer electronics device of claim 22, further comprising a data entry system for selectively inputting the viewer, time range and content-based specifications into the non-volatile memory for storage.

34. The consumer electronics device of claim 22, wherein the non-volatile memory includes a look-up list for storing a plurality of viewer specifications and associated time range and content-based specifications.

35. The consumer electronics device of claim 23, wherein the program signal carries the content-based indicator and timing information, and further comprising a data extraction device coupled to the logic unit for extracting the content-based indicator and timing information.
